(19) United States
(12) Patent Application Publication
(10) Pub. No.: US 2006/0012582 A1
(43) Pub. Date: Jan. 19, 2006

(54) Transparent film measurements

(76) Inventor: Xavier Colonna De Lega, Middletown, CT (US)

Correspondence Address: FISH & RICHARDSON PC, P.O. BOX 1022, MINNEAPOLIS, MN, 55440-1022, US

(21) Appl. No.: 11/180,223

(22) Filed: Jul. 13, 2005

Related U.S. Application Data
(60) Provisional application No. 60/588,138, filed on Jul. 15, 2004.

(51) Int. Cl. G09G 5/00; G09G 3/30

(52) U.S. Cl. 345/176; 345/206; 345/80

(57) ABSTRACT

Transparent film measurement techniques are disclosed.

### RELATED APPLICATIONS

This application claims the benefit of U.S. Provisional Application Ser. No. 60/588,138, filed Jul. 15, 2004, which application is incorporated by reference herein.

### TECHNICAL FIELD

This invention relates to measurements of layers (e.g., transparent films).

### BACKGROUND

Interferometry (e.g., scanning white light interferometry (SWLI)) can be used to determine a spatial property of an object (e.g., a height of a portion of an object or a thickness of a layer of the object). For objects having a layer overlying an interface, the SWLI data may include two spaced part interference patterns respectively resulting from the substrate-layer interface and layer-air interface. If the interference patterns are entirely separable (i.e., if there is a region of zero modulation between the two patterns), then the data can provide independent information about the substrate-layer interface and layer-air interface using standard techniques. As the overlying layer becomes thinner, the respective interference patterns begin to overlap and distort one another. Such overlapped interference patterns can provide erroneous spatial information related to the substrate-layer interface and the layer thickness.

### SUMMARY

The invention relates to measurements of layers (e.g., transparent films).

In one aspect, the invention relates to a method that includes determining a height profile of a first interface of an object based on measurement data of the object, determining a height profile of a second interface of the object based on the measurement data and a model of a shape of the second interface, and determining a profile of a distance between the first and second interfaces based on the height profiles of the first and second interfaces.

The measurement data can be optical interferometry data (e.g., low coherence scanning interferometry data).

The first interface can be between the ambient and an outer surface of a layer of the object and the second interface can be between an inner surface of the layer of the object and a surface of a second layer of the object.

Determining a height profile of the second interface can include identifying a subset of the measurement data including at least some measurement data uncorrupted by a proximity of the first and second interfaces.

The shape can be, for example, a planar shape, a hemispherical, or a parabolic shape.

In some embodiments, the method includes determining a height of each of multiple spatial locations of an outer surface of a layer of an object based on measurement data of the object, determining an estimated thickness of each of multiple spatial locations of the layer based on the measurement data of the object, and for each of multiple spatial locations of the object, determining a relationship between the height of the outer surface and the thickness of the layer.

The method can further include determining a subset based on the relationship between the height of the other surface and thickness of the layer and determining an improved thickness of each of multiple spatial locations of the layer based on the subset. Determining the improved thickness can include fitting a model of a shape of a least a portion of the object to the subset.

The relationship can be expressed as a scatter plot.

Determining the relationship can include identifying spatial locations of the object for which the measurement data related to the thickness of the layer is uncorrupted by the thickness of the layer.

In another embodiment, the method includes (a) determining spatial information for each of multiple spatial locations of a first interface of an object based on measurement data of the object, (b) determining spatial information for each of multiple spatial locations of a second interface of the object based on measurement data of the object and a shape of the second interface, and (c) determining a distance between the first and second interfaces for each of multiple spatial locations of the object based on the spatial information of the multiple spatial locations of the first interface and the spatial information of the multiple spatial locations of the second interface.

The first interface can be between surroundings of the object and an outer surface of an outer layer of the object. The second interface can be between an inner surface of the outer layer and a surface of an underlying layer of the object. Each distance between the first and second interfaces may correspond to a thickness of outer layer.

The second interface may have a higher optical reflectivity than the first interface.

The measurement data of the step of (a) determining and the measurement data of the step of (b) determining may be optical interferometry data (e.g., low coherence optical interferometry data).

The step (b) determining can include determining spatial information for a number N spatial locations of the interface based on measurement data corresponding to a smaller number N′ spatial locations of the object and the shape of the second interface.

In another embodiment, the method includes determining measurement data related to at least two of (a) a thickness of a layer of an object, (b) an outer interface of the layer (e.g., an outer surface of the object), and (c) an interface underlying the layer (e.g., an interface between the layer and a substrate underlying the layer). Typically, one of the measurement data (e.g., one of (a), (b), or (c)) has little or no systematic error. For example, substantially all of the error in that measurement may be due to random noise unrelated to properties (e.g., layer thickness) of the object. On the other hand, at least some data of the other two measurement data (e.g., two of (a), (b), or (c)) may be corrupted by error (e.g., systematic error) related to properties (e.g., layer thickness) of the object.

A relationship is determined for two of the at least two of (a), (b), and (c). For example, a scatter plot can be formed of data couples in which each couple indicates the values of the measurement data of the two of (a), (b), and (c) for a different spatial location of the object. Based on the relationship, a subset of the data couples is selected. Typically, the data couples of the subset exhibit a substantially non-random relationship (e.g., a relationship that can be approximated by a line). The subset corresponds to spatial locations for which the values of both members of each data couple are uncorrupted by error related to properties of the object. A model of a shape of at least a portion of the object is fit to the values of the measurement data of one of the members of the data couples of the subset. The fitted model (e.g., parameters of the fitted model) is used (e.g., by extrapolation) to determine an improved estimate of a spatial property of the object even for portions of the object for which the measurement data is corrupted by systematic error.

In another aspect, an apparatus includes software configured to perform a method of described herein.

In another aspect, a system includes an interferometer and a processor configured to perform a method described herein.

An application of interest is the measurement of the thickness of a top layer of an arbitrarily complex and unknown multilayer film structure. A tool used for the measurement can be an optical profiling interferometer using a low-coherence source. Because of complex interference phenomena that take place within multilayer stacks it is frequently the case that the topography of the top surface can be established without problem while the thickness measurement itself is more difficult, leading to unreliable data mixed with possibly few valid thickness samples. Such measurement failures can especially appear in regions where the film thickness is tapering down to zero.

In some embodiments, the invention provides a means of calculating a film thickness profile by combining the available topography data, the valid thickness data and a priori information about the form of the substrate.

In certain embodiments, the invention combines top surface topography information and possibly sparse thickness information to calculate the thickness profile of the top layer of an unknown and arbitrarily complex multilayer transparent structure, given a priori information on the profile of the substrate.

In an embodiment, a diagram of topography versus thickness selects reliable thickness data samples. The known substrate form defines the shape of the expected curve in the diagram. The data points that follow this curve within some tolerance are selected as valid. These selected samples are then used to calculate the location of the substrate with respect to the measured top surface topography. The difference of the two maps, possibly corrected for the effect of the refractive index and interferometer illumination, is a measure of film thickness.

One benefit is the ability to profile thickness maps that taper all the way to zero thickness. Measuring such tapers directly can be very challenging owing to the complex interference phenomenon that takes place for films that are less than a few micrometers thick. The measurement of the topography of the top surface is usually less challenging, for example using a low-coherence interference microscope and dedicated software. The invention provides a means of combining top surface topography acquired over a significant section of the measured surface with a limited number of valid thickness samples to generate a thickness map that covers as much area as the original topography data.

Another benefit is the ability to discriminate between valid and invalid thickness measurement points using the diagram of height versus thickness and the a priori information relative to the form of the substrate or underlying layer. This can be a source of the robustness of the technique.

Other features, objects, and advantages of the invention will be apparent from the following detailed description.

Unless otherwise defined, all technical and scientific terms used herein have the same meaning as commonly understood by one of ordinary skill in the art to which this invention belongs. If there is a conflict between a document incorporated herein and this document, this document controls. Unless otherwise specified, all spatial information referred to herein (e.g., heights and thicknesses) can be relative or absolute.

### BRIEF DESCRIPTION OF THE DRAWINGS

FIG. 1 illustrates an object having a layer and a substrate and a low coherence interference signal obtained from the object.

FIG. 2A illustrates a synthetic height profile of a substrate of an object and a synthetic thickness profile of a layer on the substrate. The substrate topography is planar and tilted and the thickness profile is uniform.

FIG. 2B illustrates a relationship between a height profile of an outer surface of the layer of the object of FIG. 2A and the thickness profile of the layer.

FIG. 3A illustrates a synthetic height profile of a substrate of an object and a synthetic thickness profile of a layer on the substrate. The substrate topography is parabolic and the thickness profile is uniform.

FIG. 3B illustrates a relationship between a height profile of an outer surface of the layer of the object of FIG. 3A and the thickness profile of the layer.

FIG. 4A illustrates a synthetic height profile of a substrate of an object and a synthetic thickness profile of a layer on the substrate. The substrate topography is planar and untilted and the thickness profile is parabolic.

FIG. 4B illustrates a relationship between a height profile of an outer surface of the layer of the object of FIG. 4A and the thickness profile of the layer.

FIG. 5A illustrates a synthetic height profile of a substrate of an object and a synthetic thickness profile of a layer on the substrate. The substrate topography is planar and tilted and the thickness profile increases linearly across the substrate.

FIG. 5B illustrates a relationship between a height profile of an outer surface of the layer of the object of FIG. 5A and the thickness profile of the layer.

FIG. 6A illustrates a synthetic height profile of a substrate of an object and a synthetic thickness profile of a layer on the substrate. The substrate topography is planar and tilted and the thickness profile is parabolic.

FIG. 6B illustrates a relationship between a height profile of an outer surface of the layer of the object of FIG. 6A and the thickness profile of the layer.

FIG. 7 illustrates a height profile of an outer surface of a layer of an object as determined based on optical interferometry data of the object. The object includes a substrate underlying the layer.

FIG. 8 illustrates a thickness profile of the layer of the object of FIG. 7 as determined based on the optical interferometry data.

FIG. 9 illustrates, for each of multiple locations of the outer surface of the layer of the object of FIG. 7, a relationship between the height of the outer surface at that location and the thickness of the layer at that location.

FIG. 10 illustrates a two-dimensional histogram of the data of FIG. 9.

FIG. 11A illustrates a point-by-point gradient of FIG. 10.

FIG. 11B illustrates the gradient of FIG. 11A with a superimposed linear segment identified by an edge finding algorithm.

FIG. 12 illustrates the data of FIG. 9 with a subset of data points indicated.

FIG. 13 illustrates, for each of multiple locations of the outer surface of the layer of the object of FIG. 7, a relationship between the height of the outer surface at that location and the thickness of the layer at that location, the relationship being determined after subtracting from each height of the outer surface of the layer a height of the substrate at a corresponding location. A subset of the data points is indicated.

FIG. 14 illustrates a histogram of the data of FIG. 13.

FIG. 15 illustrates a profile of the thickness of the layer of the object of FIG. 7 as determined based on the optical interferometry data and a model of the shape of the substrate, the model being fit to the points of the subset of FIG. 13.

FIG. 16 illustrates an exemplary interferometer system for obtaining optical interferometry data.

### DETAILED DESCRIPTION

Optical interferometry (e.g., low coherence scanning interferometry such as SWLI) can be used to determine spatial information (e.g., height or thickness information) of objects. In general, the height of a spatial location of an object relates to a position in space of that spatial location (e.g., the height of a spatial location of an object can be expressed as the distance of that spatial location from some reference). A height profile includes height information for multiple spatial locations. Typically, the height information of the multiple spatial locations is expressed with respect to a common reference surface (e.g., a common reference plane).

Exemplary, optical interferometry techniques are described in U.S. Pat. No. 5,398,113 to de Groot and U.S. patent application Ser. No. 10/941,649, entitled “METHODS AND SYSTEMS FOR INTERFEROMETRIC ANALYSIS OF SURFACES AND RELATED APPLICATIONS,” filed Sep. 15, 2004, which documents are incorporated herein by reference. Described techniques include determining information about a test object based on interference signals by transform-based methods (e.g., frequency domain analysis (FDA)) and correlation of optical interference signals with a template.

In some applications, the spatial information is a thickness of a layer of an object (e.g., the thickness of an outer layer overlying another material (e.g., a substrate or another layer)). A layer's thickness is related to the distance between the outer surface of the layer and the interface between the layer and the underlying material. The thickness can be determined, for example, directly (e.g., based on the optical interferometry data) or indirectly (e.g., based on the difference between the height of the outer surface and the height of the interface, where the heights can be determined based on optical interferometry data).

Measurement data of spatial information of the outer surface of the layer (e.g., the height of the layer) can typically be established without significant error. Measurement data of spatial information related to the interface underlying the layer is typically corrupted by errors (e.g., systematic errors) resulting from various sources. In some cases, interference phenomena related to, for example, the proximity (e.g., closeness) of the interfaces of the layer can corrupt the data. Errors are particularly likely when the layer is thin (e.g., about 2 microns thick or less, about 1 micron thick or less). Other sources of errors can corrupt the measurement data even for thicker layers. For example, measurement data of thicker layers (e.g., about 10 microns or more, about 20 microns or more) obtained using a high numerical aperture objective can also be corrupted. Some sources of error may be unrelated to the thickness of the layer. For example, the interface underlying the layer may have a low reflectivity because, for example, a small refractive index difference at the interface or absorption by the substrate. The low reflectivity can degrade optical interferometry data obtained from the interface.

Sources of error such as those just described can corrupt direct and/or indirect determination of a layer's thickness. Such errors are typically greater than amount of error in the absence of such effects. For example, the standard deviation of corrupted measurement data is typically higher than the standard deviation of measurement data in the absence of such errors (e.g., at least twice as large, at least three times, as large, at least four times as large, at least five times as large or more). Because the errors may not be readily apparent, one might rely on erroneous thickness data without knowledge that they are erroneous.

We disclose methods and related systems for determining spatial information related to a layer of an object for one or more spatial locations of the object. The spatial information typically includes a thickness of the layer and/or a height of an interface between the layer and an underlying material.

In an exemplary embodiment, spatial information (e.g., height information) is determined based on measurement data (e.g., optical interferometry data) for each of multiple spatial locations of an outer surface of a layer of an object. Spatial information (e.g., height information) is also determined based on measurement data (e.g., optical interferometry data) for each of multiple spatial locations of an interface between the layer and the underlying material. A model of the shape of the interface (e.g., a model of the height profile of the interface) is fit to the spatial information of at least some of the multiple spatial locations of the interface. For example, if the shape of the interface is known to be planar, a model of a planar shape is fit (e.g., by least squares) to the heights of the interface. Typically, the model is fit to heights of spatial locations for only portions of the object for which the interface measurement data are uncorrupted. Parameters of the fitted model are then used to determine spatial information (e.g., height) for spatial locations of the interface. For example, the heights of portions of the interface not fit by the model can be determined by extrapolating the fitted model. Consequently, spatial information of the interface can be determined even for spatial locations for which the measurement data are corrupted by errors. The thickness profile of the layer is determined based on the heights of multiple spatial locations of the outer surface of the layer and the heights of corresponding spatial locations of the interface, where the interface heights are determined based on the fitted parameters of the model.

Also disclosed are methods and related systems for determining whether measurement data of an object (e.g., related to height data of an interface and/or thickness data of a layer) are corrupted by errors. Typically, the method includes determining, for each of multiple spatial locations of an object, a relationship between a height of the outer interface (e.g., outer surface) of a layer of the object and spatial information related to the layer (e.g., the thickness of the layer and/or the height of an interface underlying the layer). For example, the method can include preparing a scatter plot with multiple data point couples each giving the height of a spatial location of the outer surface of the layer and the thickness of the layer corresponding to that spatial location. The relationship between the height/thickness data (e.g., correlation between the height/thickness data) has a shape that depends on whether the thickness data are corrupted by errors or not. For example, data points corresponding to spatial locations for which the measurement data are corrupted are generally randomly distributed while points corresponding to spatial locations for which the data are uncorrupted are generally non-randomly distributed (e.g., linearly distributed or distributed according to a higher order relationship (e.g., parabolic)). Accordingly, one can determine from the relationship of the height/thickness data whether measurement data from a particular portion of the object are corrupted (or uncorrupted) by systematic errors. Uncorrupted measurement data and a model of a shape of the object can be used to determine spatial information for spatial locations for which the measurement data are corrupted.

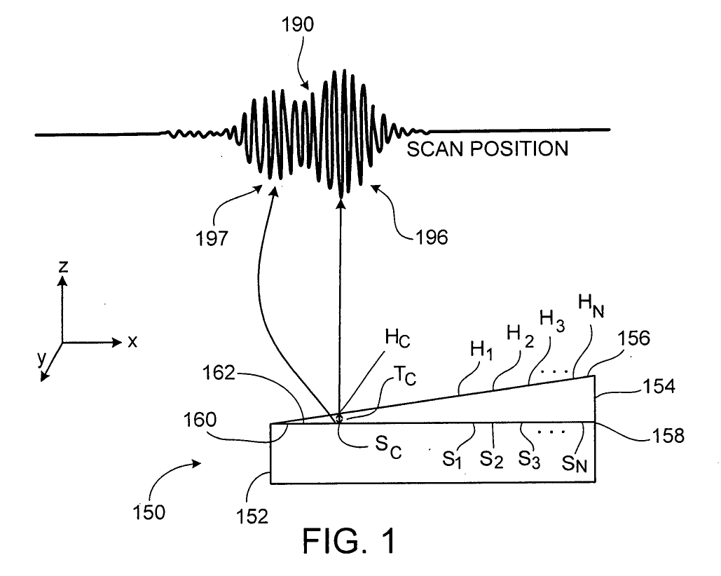

Referring to FIG. 1, an object 150 includes a substrate 152 and a layer 154 having an outer surface 156 that defines an interface between object 150 and its surroundings. Object 150 also includes an interface 158 between an inner surface 160 of layer 154 and a surface 162 of substrate 152. The topography of interface 158 is typically determined by and is typically the same as surface 162 of substrate 152. The height Hi of the ith spatial location of surface 156 is given by Hi=Ti+Si, where Ti is the thickness of layer 154 at a spatial location corresponding to the ith spatial location of surface 156 and Si is the height of substrate 152 at a spatial location corresponding to the ith spatial location of surface 156.

Optical interferometry (e.g., low coherence interferometry) can be used to determine Hi, Ti, and Si. An interference signal 190 illustrates a low coherence interference signal that might be obtained from the ith spatial location of object 150. Interference signal 190 includes a first interference pattern 196 resulting from a spatial location of interface 156 and a second interference pattern 197 resulting from a corresponding spatial location of interface 158. The interference patterns 196,197 map out a number of oscillations (e.g., fringes) that decay according to a low coherence envelope that does not expressly appear in such interference signals. The width of the coherence envelope corresponds generally to the coherence length of the detected light, which is related to the effective spatial frequency spectrum of the interferometer along the scan dimension. Among the factors that determine the coherence length are temporal coherence phenomena related to, for example, the spectral bandwidth of the light, and spatial coherence phenomena related to, for example, the range of angles of incidence of light illuminating the test object. As can be seen in FIG. 1, interference signals 196,197 result from detecting the interference signal 190 over a range of positions that is greater than the width of the coherence envelope.

Typically, the heights of outer surface 156 and interface 158 are determined from measurement data (e.g., optical interferometry data) and the thickness of the layer is determined indirectly based on the difference between the heights. However, for some locations of object 150, the determined height of the interface can be corrupted by errors resulting from interference effects. For example, because the true thickness Tc of layer 154 between spatial locations Hc and Sc is relatively thin (e.g., about 1 micron or less), first and second interference patterns 196,197 overlap one another. Consequently, height Sc and/or thickness Tc as determined from the difference between heights Hc and Sc can be corrupted. On the other hand, other spatial locations of interface 158 (e.g., S₁-S_{N}) underlie thicker portions of layer 154. Therefore, the height of interface 158 (e.g., heights S₁-S_{N}) can be determined unambiguously based on measurement data of the object.

We next describe how to determine spatial information for layer 154 and interface 158 for spatial locations for which the measurement data is corrupted (e.g., Sc) based on measurement data which is not corrupted (e.g., S₁-S_{N}).

In some situations, the shape of the interface underlying an object is known or can be predicted. For example, FIG. 1 shows that interface 158 underlying layer 154 is planar. A model of the planar shape of interface 158 is fit (e.g., by least-squares) to heights S₁. . . S_{N} of substrate 152. Parameters of the fitted model are then used to determine the heights of other spatial locations of interface 158. For example, height Sc can be determined by extrapolation of the parameters determined from the fit to heights S₁ . . . S_{N}. In general, the thickness Tᵢ of layer 154 for any spatial location of the object can be determined from the difference between Hᵢ and S′ᵢ, where Hᵢ is the height of a corresponding spatial location of surface 156 determined from measurement data and S′ᵢ is the height of a corresponding spatial location of interface 158 determined from parameters of a model fit to the heights of multiple spatial locations of an interface between the layer and underlying material.

While a method for determining spatial information based on measurement data and a model of a shape of a portion of an object has been described where that shape is planar, the object may have other shapes in part or in whole. For example, the shape may be at least partially spherical, at least partially parabolic, at least partially convex, or at least partially concave. In general, the method can be performed where the object or portion thereof has a shape that can be modeled.

In some cases, a model is fit to only a subset of the measurement data (e.g., a subset of the measurement data determined to be uncorrupted). In other cases, a model is fit to all of the measurement data. The measurement data can be weighted in the fitting process. For example, data known or predicted to be uncorrupted can be given more weight than data known or predicted to be uncorrupted.

We next describe a method for determining whether measurement data related to an object (e.g., to data related to Ti or Si) are corrupted. The method typically includes providing measurement data indicative of the outer surface heights Hi of a layer of the object and measurement data indicative of the layer thicknesses Ti and/or substrate heights Si of the object. A relationship between the heights Hi and the thicknesses Ti (or between heights Hi and heights Si) is determined. Based on the relationship, spatial locations are identified for which the measurement data (e.g., Ti or Si) is uncorrupted. Typically, the height/thickness relationship for spatial locations with uncorrupted measurement data is determined by the shapes of the layer thickness and interface profiles. Hence, the height/thickness relationship is non-random for spatial locations with uncorrupted measurement data. The height/thickness relationship for spatial locations with corrupted measurement data is not directly related to the shapes of the layer thickness and interface profiles. Hence, the height/thickness relationship tends to be random for spatial locations with corrupted measurement data.

Examples of the height/thickness relationships for different layer thickness and substrate profiles are discussed next.

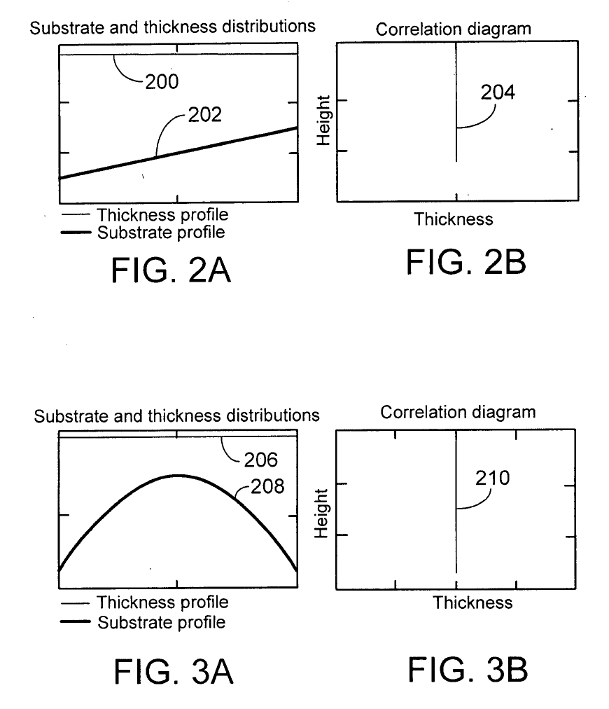

Referring to FIG. 2A, a profile 200 of the thickness Ti an outer layer of an object is uniform in cross-section. A profile 202 of the height Si of the substrate underlying the outer layer is linear in cross-section but tilted. The linear cross-sectional profile of the substrate corresponds to a planar substrate profile in two dimensions.

Referring to FIG. 2B, the relationship 204 between the object heights Hi (where Hi=Ti+Si) and thicknesses Ti exhibits a linear, vertical relationship. Each point of the line is a data couple giving the height Hi and thickness Ti of a spatial location of the object.

Referring to FIG. 3A, a profile 206 of the thickness Ti an outer layer of an object is uniform in cross-section. A profile 208 of the height Si of the substrate underlying the outer layer is parabolic and untilted.

Referring to FIG. 3B, the relationship 210 between the object heights Hi (where Hi=Ti+Si) and thicknesses Ti exhibits a linear, vertical relationship.

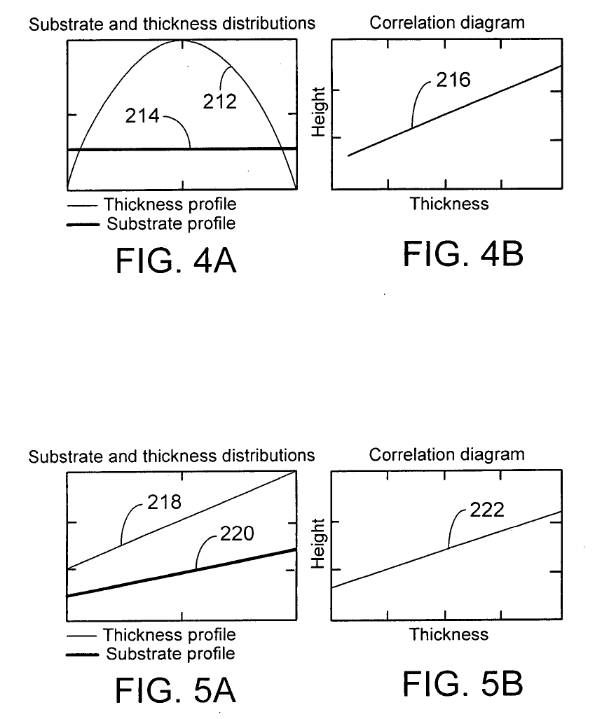

Referring to FIG. 4A, a profile 212 of the thickness Ti an outer layer of an object has is parabolic in cross-section. A profile 214 of the height Si of the substrate underlying the outer layer is linear (e.g., planar) in cross-section and untilted.

Referring to FIG. 4B, the relationship 216 between the object heights Hi (where Hi=Ti+Si) and thicknesses Ti exhibits a linear, sloped relationship.

Referring to FIG. 5A, a profile 218 of the thickness Ti an outer layer of an object is linearly sloped in cross-section. A profile 220 of the height Si of the substrate underlying the outer layer is linear (e.g., planar) in cross-section and tilted.

Referring to FIG. 5B, the relationship 222 between the object heights Hi (where Hi=Ti+Si) and thicknesses Ti exhibits a linear, sloped relationship.

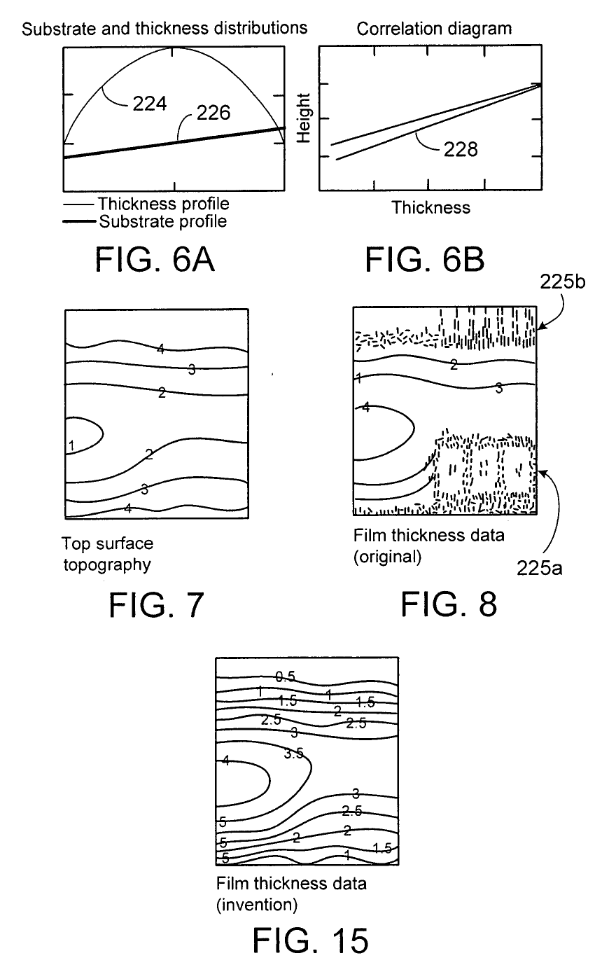

Referring to FIG. 6A, a profile 224 of the thickness Ti an outer layer of an object is parabolic in cross-section. A profile 226 of the height Si of the substrate underlying the outer layer is linear (e.g., planar) in cross-section and tilted.

Referring to FIG. 6B, the relationship 228 between the object heights Hi (where Hi=Ti+Si) and thicknesses Ti exhibits two linear branches.

FIGS. 2B, 3B, 4B, 5B, and 6B illustrate that for a variety of layer thickness profile-substrate shape combinations, at least a portion of the relationship between the heights Hi of the outer layer and the thicknesses Ti of the outer layer is non-random and can typically be approximated by a line (e.g., as linear or curved (e.g., parabolic or by a polynomial such as a second order polynomial)). Even for the more complicated profile-shape combination of FIG. 6A, the height/thickness relationship (FIG. 6B) is non-random and each two branch of the relationship 228 can be approximated as linear.

While FIGS. 2B, 3B, 4B, 5B, and 6B illustrate the relationship between heights Hi and thicknesses Ti without contributions from noise unrelated to the proximity of the outer and inner interfaces of the object, the height/thickness relationship for actual measurement data is similar. Uncorrupted height/thickness data couples can generally be approximated by a line and the height/thickness data couples generally deviate from the line by an amount related to the random noise level of the instrument(s) used to determine the height/thickness data. Corrupted height/thickness data couples, on the other hand, cannot generally be well approximated by a line and generally exhibit significantly greater spread than uncorrupted data couples. Hence, spatial locations for which measurement data are uncorrupted (e.g., by the proximity of adjacent interfaces) can be identified based on the height/thickness relationship for multiple data couples.

In some embodiments, spatial locations for which the measurement data is uncorrupted are identified by determining a density of height/thickness data couples. For example, the density of data couples can be determined based on a two-dimensional histogram created from a scatter plot of heights Hi vs. thicknesses Ti. A grid is superimposed upon the scatter plot. The spacing between intersections of the grid is typically about the same or somewhat greater than the resolution of the instrument(s) used to obtain the measurement data. Each height thickness data couple of the scatter plot is assigned to the nearest intersection of the grid. The two-dimensional histogram is determined from the number of data couples assigned to each intersection. Data couples corresponding to spatial locations for which the measurement data are uncorrupted generally have a higher density than data couples corresponding to spatial locations for which the measurement data are corrupted.

The two-dimensional histogram can be processed (e.g., by using image processing functions such as edge finding algorithms) to identify spatial locations for which the measurement data are uncorrupted. In some embodiments, an edge finding algorithm is used to identify sharp density variations that can occur along the boundaries between subsets of the measurement data corresponding to spatial locations for which the data are uncorrupted and subsets of data for which the measurement data are corrupted. Once such a boundary has been identified, data couples that are, for example, within a fixed distance from the edge or from a linear segment derived from a fit to the edge shape, can be selected. The measurement data corresponding to the substrate height Si at spatial locations of the selected data couples are used to determine a best fit to the interface 158.

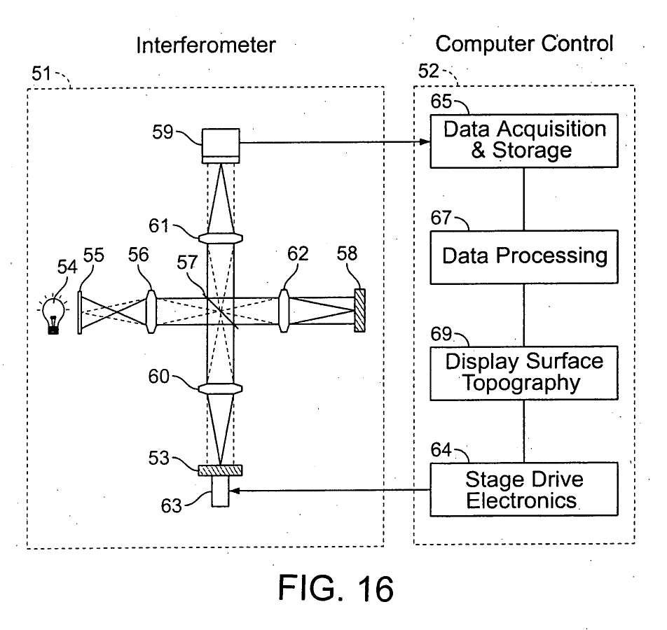

Referring now to FIG. 16, we describe an exemplary interferometer system 50 for obtaining optical interferometry data (e.g., optical interferometry data including low coherence interference signals). System 50 includes an interferometer 51 and a processor 52 (e.g., an automated computer control system). The measurement system 50 is operable to obtain scanning interferometry data of spatial locations of a test object 53.

Measurement system 50 includes a light source 54, a first focusing optic (e.g., one or more lenses) 56, a beam splitting element 57, a second focusing optic 62, a reference object 58, a third focusing optic 60, and a detector 59. Light source emits 54 emits spectrally-broadband light (e.g., white light), which illuminates a diffusing screen 55. First focusing optic 56 collects light from screen 55 and transmits collimated light to beam-splitting element 57, which splits the collimated light into first and second portions. A first portion of the collimated light is received by second focusing optic 62, which focuses the first portion of the light onto reference object 58. Light reflected from the reference object is received by second focusing optic 62, which transmits collimated light reflected by the reference object 58 back to beam-splitting element 57. Beam-splitting element 57 directs the second portion of the collimated light to third focusing optic 60, which focuses the light onto test object 53. Light reflected from test object 53 is received by third focusing optic 60, which transmits collimated light reflected by test object 53 back to beam-splitting element 57. Beam-splitting element 57 combines light reflected from reference object 58 and test object 53 and directs the combined light to a fourth focusing optic 61, which focuses the combined light to a detector 59.

Detector 59 is typically a multidimensional detector (e.g., a charge coupled device (CCD) or charge injection device (CID)) having a plurality of detector elements (e.g., pixels) arranged in one or more dimensions (e.g., two dimensions). Optics 60 and 61 focus light reflected from test object 53 onto detector 59 so that each detector element of detector 59 receives light reflected from a corresponding spatial location (e.g., a point or other small region) of test object 53. Light reflected from respective spatial locations of test object 53 and light reflected from reference object 58 interferes at detector 59. Each detector element produces a detector signal related to the intensity of the interfering light.

System 50 is configured to measure interference signals related to spatial locations of test object 53. Typically, system 50 creates an OPD between light reflected from reference object 58 and light reflected from test object 53. For example, test object 53 can be displaced through a number of scan positions along a scan dimension axis by a scan mechanism (e.g., an electromechanical transducer 63 (e.g., a piezoelectric transducer (PZT)), and associated drive electronics 64) controlled by computer 52. In some embodiments, a scan position increment between successive scan positions is at least about λ/15 (e.g., at least about λ/12, at least about λ/10), where λ is a mean wavelength of the light detected at each pixel.

For each scan position, detector 59 outputs an intensity value (e.g., the intensity detected by a given detector element) for each of multiple different spatial locations of the test object. Taken along the scan dimension, the intensity values for each spatial location define an interference signal corresponding to the spatial location. The intensity values corresponding to a common scan position define a data set (e.g., an interferogram) for that scan position. System 50 can detect intensity values over a range of scan positions that is greater than the width of a coherence envelope of the detected interference signals and, therefore, greater than the coherence length of the detected light.

Processor 52 can be configured to acquire and/or store data 65, process data 67 (e.g., as described herein), display 69 surface topographies, and operate 64 components of interferometer 51. In general, any of the methods described above can be implemented, for example, in computer hardware, software, or a combination of both. The methods can be implemented in computer programs using standard programming techniques following the descriptions herein. Program code is applied to input data to perform the functions described herein and generate output information. The output information is applied to one or more output devices such as a display monitor. Each program may be implemented in a high level procedural or object oriented programming language to communicate with a computer system. However, the programs can be implemented in assembly or machine language, if desired. In any case, the language can be a compiled or interpreted language. Moreover, the program can run on dedicated integrated circuits preprogrammed for that purpose.

Each such computer program is preferably stored on a storage medium or device (e.g., ROM or magnetic diskette) readable by a general or special purpose programmable computer, for configuring and operating the computer when the storage media or device is read by the computer to perform the procedures described herein. The computer program can also reside in cache or main memory during program execution. The analysis method can also be implemented as a computer-readable storage medium, configured with a computer program, where the storage medium so configured causes a computer to operate in a specific and predefined manner to perform the functions described herein.

While scanning interferometry data have been described as being obtained by varying an OPD (e.g., by moving a test and/or reference object), other configurations are possible. For example, in some embodiments, scanning interferometry data are obtained by varying a wavelength of that light interferes at the detector. Each scan position typically corresponds to a different wavelength of detected interfering light (e.g., to a different central wavelength of the detected interfering light). Each scan position increment typically corresponds to a difference in the wavelength between scan positions.

While measurement data has been described as optical interferometry data, other types of measurement data can be used. Different measurement data or even different types of measurement data can be used for an outer surface and for an inner interface or thickness. For example, measurement data of an outer surface of an object may be determined mechanically (e.g., using a stylus). Measurement data of layers (e.g., thickness) may be determined using optical ellipsometry or reflectometry.

### EXAMPLE

This Example illustrates determination the determination of a thickness profile of a layer of an object.

A patterned semiconductor wafer coated with a thick protective film was used as a test object. A low coherence interference microscope was used to obtain optical interferometry data of the object. The data included multiple low coherence interference signals each including an interference pattern resulting from light reflected from a respective spatial location of the outer surface of the film and an interference pattern resulting from light reflected from a corresponding spatial location of the underlying interface between the film and the substrate.

The interference signals were used to determine the height Hᵢ of each of multiple spatial locations of the outer surface of the film and the height Sᵢ of each of multiple spatial locations of the interface between the film and the substrate. Referring to FIG. 7, the heights Hᵢ of the multiple spatial locations of the outer surface are illustrated as a height profile. The heights span a range of about 5 microns.

The thickness Tᵢ of each of multiple locations of the film was determined by subtracting the interface height Sᵢ from the outer surface height Hᵢ. FIG. 8 illustrates a thickness profile composed of the thicknesses Tᵢ, which span a range of about 8 microns. The thickness profile included several regions 225a and 225b in which the film thickness is about 1 micron or less and the corresponding thickness data are corrupted by interference effects.

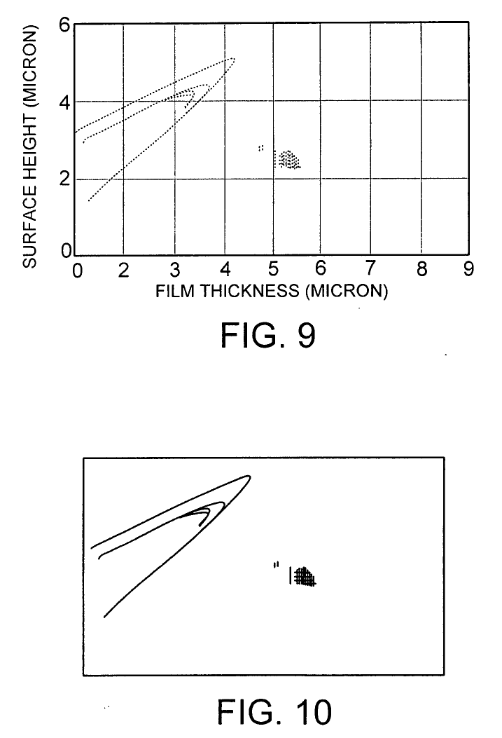

Referring to FIG. 9, a scatter plot of the height Hᵢ of each of multiple spatial locations of the outer surface of the film vs. the corresponding thickness Tᵢ illustrates a relationship between object height and film thickness. Each point of the plot corresponds to a single data couple (e.g., height and thickness).

A two-dimensional histogram was prepared from the data of the scatter plot of FIG. 9 by assigning each point to the nearest intersection of a rectangular grid having a spacing 0.1 microns. The spacing was selected on the basis of the point density and the range of observed heights and thicknesses of the data. A gray scale image was prepared from the two-dimensional histogram by converting each intersection of the grid to a grey level related to the number of points assigned to that intersection. FIG. 10 illustrates the grey scale image prepared from the scatter plot of FIG. 9.

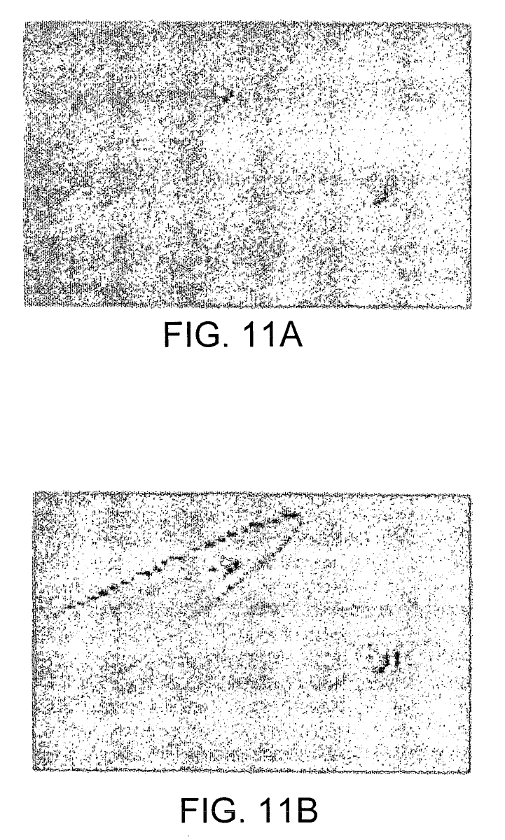

The gradient of each point of the grey scale image of FIG. 10 was determined by (a) determining the difference between that point and an adjacent horizontal point, (b) determining the difference between that point and an adjacent vertical point, and (c) summing the differences. FIG. 11A shows a plot of the gradients determined from the gray scale data of FIG. 10.

A ridge finding algorithm was used to select a subset of points from the gradient data of FIG. 11A. The edge finding algorithm starts searching at locations corresponding to greater thickness values and/or outer surface points having greater height values and identifies an edge shown as a black trace in FIG. 11B. The edge pixel locations were then used to define a straight line segment in the image and each data point in FIG. 9 located within a certain distance of this segment was selected as part of the subset of uncorrupted measurement data. The boundaries of the subset can be selected based on, for example, the amount of random, non-systematic noise in the data for data expected to be uncorrupted (e.g., the boundaries can be set as a multiple of the standard deviation (e.g., about two times the standard deviation, about 3 times the standard deviation, about 4 times the standard deviation, about 5 times the standard deviation)).

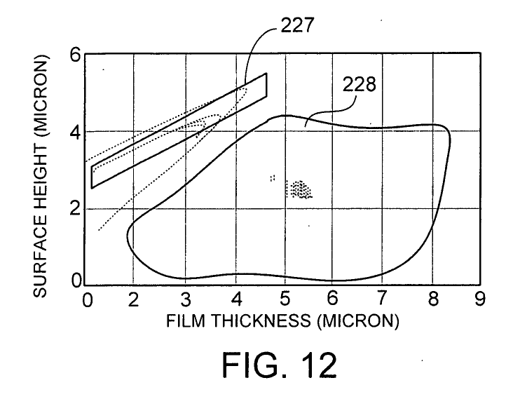

Referring to FIG. 12, a subset 227 of the measurement data had a number N′ points (height/thickness data couples) where N′ was smaller than the total number N of points of FIG. 12. The subset of points corresponded to spatial locations of the test object for which spatial information about the height of the underlying interface was unlikely to be corrupted by systematic error resulting from interference effects. As discussed above, interference effects can corrupt such spatial information when the interference patterns resulting from the film's outer surface and from the underlying interface overlap one another. Such overlap was less likely for thicker portions of the film than for thinner portions of the film. A priori information was used to guide the range of points searched by the ridge finding algorithm. Points with higher heights were searched first because, for a generally flat substrate, points corresponding to spatial locations with higher heights often correspond to thicker portions of the film.

As seen in FIG. 12, the data couples of subset 227 exhibit a generally linear relationship between height and thickness. In contrast, data couples of, for example, a subset 228 exhibit significantly greater spread and the relationship between height and thickness would not be well approximated by a line. The data couples of subset 228 are likely to be corrupted.

The height Sᵢ of the interface corresponding to each of the N′ points of the subset 227 and a model of the shape of the interface were used to determine a predicted height Sᵢ′. of the interface for each of multiple spatial locations of the interface including spatial locations for which the optical interferometry data were corrupted by interference effects. Specifically, the model of the shape of the interface was fit to the heights Sᵢ for locations corresponding to points within subset 227. In this Example, the shape of the substrate (and hence the interface with the outer layer) was known to be planar. The fit was performed by minimizing the χ² sum:

$${χ}^{2} = {\sum }_{i} {( {H}_{i} - {T}_{i} - A \cdot {x}_{i} - B \cdot {y}_{i} - C )}^{2}$$

where Hi is the height of the outer interface, Ti is the film thickness for the ith spatial location within subset 227, A, B and C are the fitting constants of the equation of the best fit plane, xᵢ is the x coordinate of the ith spatial location of subset 227, and yᵢ is the y coordinate of the ith spatial location of subset 227. While the χ² sum is expressed in terms of Hi−Ti, the χ² sum could also be expressed in terms of Si (e.g., based on the relationship Hi=Ti+Si). Using the fitting constants A, B, and C, the height Sᵢ′ of any spatial location xi,yi of the interface of the test object could be determined (e.g., by extrapolation) using:
Sᵢ′=A·xᵢ+B·yᵢ+C
The height Sᵢ′ could be subtracted from the height Hᵢ of the corresponding spatial location of the outer surface to determine a corrected film thickness Tᵢ′ even for spatial locations of the test object for which interference effects corrupted the interferometry data of the interface heights Sᵢ.

In this Example, instead of determining corrected film thicknesses Tᵢ′ based on the outer surface heights Hᵢ and predicted interface heights Sᵢ′, we first determined corrected outer surface heights Hi′ each corrected for tilt of the substrate. A relationship between the corrected heights Hi′ and film thicknesses Ti was used to determine a second subset of spatial locations for which spatial information about the height of the underlying interface was unlikely to be corrupted by systematic error resulting from interference effects. The interface heights Sᵢ corresponding to the second subset of locations and the model of the interface shape were used to determine second fitting parameters A′, B′, and C′, which, as discussed below, were expected to have enhanced accuracy and precision as compared to the fitting parameters A, B, and C. Corrected thicknesses Ti″ were determined based on the second fitting parameters A′, B′, and C′. This process is discussed next.

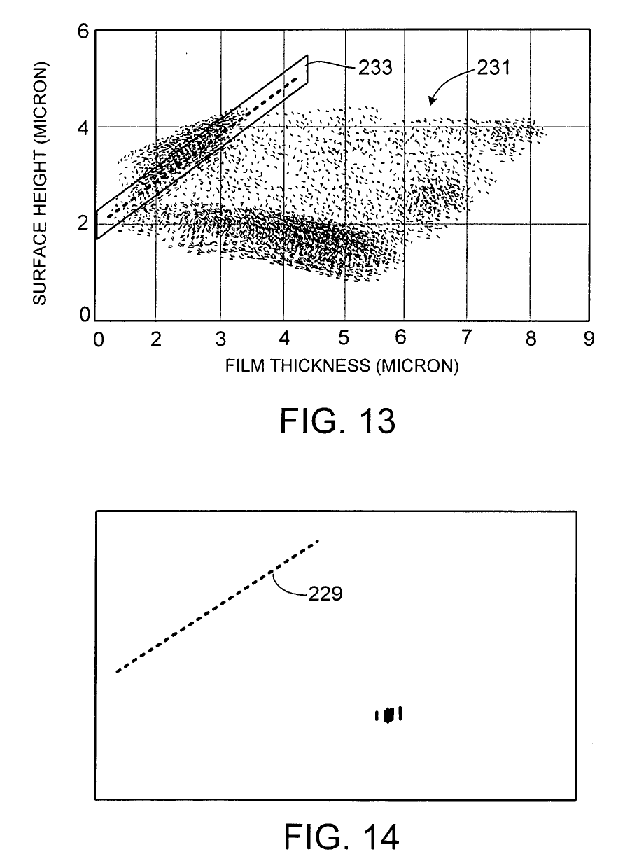

The tilt-corrected height Hᵢ′ of each spatial location of the outer surface was determined by subtracting the tilt component of the height Sᵢ of the corresponding spatial location of the interface as determined from the fitting constants A, B, and C:
Hᵢ′=Hᵢ−Axᵢ−Byᵢ
where H′ is the tilt-corrected height of the ith spatial location of the outer surface. FIG. 13 illustrates a scatter plot of the tilt corrected heights Hᵢ′ and the film thickness Tᵢ corresponding to the spatial location of each corrected height. A histogram was formed from the tilt corrected heights Hᵢ′ and converted to a grey scale image as discussed above. FIG. 14 illustrates the grey scale image of the tilt corrected heights. Substantially all of the grey levels fall along a single line segment 229. Grey levels 231 not falling on line segment 229 are less likely to correspond to uncorrupted thickness values because, for spatial locations corresponding to grey levels 231, there is a substantially greater spread of the relationship between the corrected height Hᵢ′ and the corresponding thickness value Tᵢ. In contrast, spatial locations corresponding to grey levels falling on line segment 229 exhibit a linear relationship between the heights Hᵢ′ and thicknesses Tᵢ.

We note that FIGS. 9 and 13 are related in terms of the relationship between height and thickness just as FIGS. 4B and 6B are related. Specifically, FIGS. 4B and 9 illustrate the outer surface height-film thickness relationship for a non-uniform film thickness profile on a tilted planar substrate and FIGS. 6B and 13 illustrate the outer surface height-film thickness relationship for the same non-uniform thickness profile but on a flat planar substrate.

Returning to the Example, a second subset 233 of points was selected based on the relationship between the tilt corrected heights Hᵢ′ and the thicknesses Ti shown in FIG. 13. The same edge finding algorithm was used to find the pixels that constitute segment 229. These pixel positions were then used to fit the equation of a line segment that was then used to define a bounding region 233. Because the points within the second subset exhibit a non-random relationship (e.g., linear) between height Hᵢ′ and thickness Tᵢ, the measurement data related to the substrate heights Si for spatial locations corresponding these points are expected to be uncorrupted by interference effects. The interface heights Si corresponding to points within subset 231 were used to determine second fitting parameters A′, B′, and C′ as discussed above. The second fitting parameters were expected to be more accurate and precise than the fitting parameters A, B, and C because a greater number of heights Si distributed over a greater area of the substrate are present in subset 233 (FIG. 13) as compared to subset 227 (FIG. 12) before tilt-correction of the measurement data. The second fitting parameters were used to determine a corrected interface height Sᵢ″=A′xᵢ+B′yᵢ+C′ for each of multiple spatial locations xᵢ,yᵢ of the test object.

The corrected interface heights Sᵢ″ were used to determine corrected film thicknesses Tᵢ″=Hᵢ−Sᵢ″ for each of multiple spatial locations of the test object. FIG. 15 illustrates a map of the thicknesses Tᵢ″ corrected for interference effects. A comparison of FIGS. 8 and 15 reveals that the film thickness profile determined from the corrected Tᵢ″ values tapers cleanly to zero in regions 225a,225b, whereas the film thickness profile determined from the uncorrected Tᵢ values includes invalid thickness data.

Note that an edge finding algorithm could have been applied directly to the grey level data shown in FIG. 10. Another approach is to identify a point in the two-histogram for which the density is high and then propagate along the ridge that passes through this point. Propagation can be accomplished by looking for the largest-valued nearby pixel in the columns located to the left and to the right of the starting pixel.

It will be understood that various modifications may be made without departing from the spirit and scope of the invention. Accordingly, other embodiments are within the scope of the following claim.

What is claimed is:

1. A method, comprising:
determining a height profile of a first interface of an object based on measurement data of the object;
determining a height profile of a second interface of the object based on the measurement data and a model of a shape of the second interface; and
determining a profile of a distance between the first and second interfaces based on the height profiles of the first and second interfaces.

2. The method of claim 1, wherein the measurement data comprises optical interferometry data.

3. The method of claim 2, wherein the optical interferometry data comprises low coherence scanning interferometry data.

4. The method of claim 1, wherein the first interface is between the ambient and an outer surface of a layer of the object and the second interface is between an inner surface of the layer of the object and a surface of a second layer of the object.

5. The method of claim 1, wherein determining a height profile of the second interface comprises identifying a subset of the measurement data comprising at least some measurement data uncorrupted by a property of at least one of the first and second interfaces.

6. The method of claim 5, wherein the property is a proximity of at least one of the first and second interfaces.

7. The method of claim 5, wherein the property is a low reflectivity of the second interface.

8. The method of claim 5, wherein determining the height profile of the second interface comprises fitting the model to the measurement data of the subset.

9. The method of claim 1, wherein the shape is a planar shape, a hemispherical, or a parabolic shape.

10. An apparatus comprising software configured to perform the method of claim 1.

11. A system comprising an interferometer and a processor configured to perform the method of claim 1.

12. A method, comprising:
determining a height of each of multiple spatial locations of an outer surface of a layer of an object based on measurement data of the object;
determining an estimated thickness of each of multiple spatial locations of the layer based on the measurement data of the object; and
for each of multiple spatial locations of the object, determining a relationship between the height of the outer surface and the thickness of the layer.

13. The method of claim 12, further comprising determining a subset of the multiple spatial locations of the layer based on the relationship between the height of the other surface and thickness of the layer and determining an improved thickness of each of multiple spatial locations of the layer based on the subset.

14. The method of claim 13, wherein determining the improved thickness comprises fitting a model of a shape of a least a portion of the object to the subset.

15. The method of claim 12, wherein the relationship is expressed as a scatter plot.

16. The method of claim 12, wherein determining the relationship comprises identifying spatial locations of the object for which the measurement data is uncorrupted by a property of the layer.

17. The method of claim 16, wherein the property is a proximity of interfaces of the layer.

18. The method of claim 16, wherein the property is a reflectivity of an interface of the layer.

19. The method of claim 12, wherein the measurement data comprises optical interferometry data.

20. The method of claim 19, wherein the optical interferometry data comprises low coherence scanning interferometry data.

21. An apparatus comprising software configured to perform the method of claim 12.

22. A system comprising an interferometer and a processor configured to perform the method of claim 12.

23. A method, comprising:
(a) determining spatial information for each of multiple spatial locations of a first interface of a layer of an object based on measurement data of the object;
(b) determining a thickness of the layer for multiple spatial locations each corresponding to one of the multiple spatial locations of the first interface based on the measurement data; and
(c) determining whether the thickness determined at each of the multiple spatial locations meets a selected criterion based on a relationship between the spatial information of the multiple spatial locations of the first interface of the layer and the thickness corresponding to the multiple spatial locations of the first interface of the layer.

24. The method of claim 23, wherein the determining (c) comprises fitting a line to at least some of the spatial information of the first interface and the thicknesses and the selected criterion is a distance from the line.

25. The method of claim 24, wherein the determining (c) comprises forming a scatter plot of the at least some spatial information of the first interface and the thicknesses, and fitting a line comprises fitting a line to at least a portion of the scatter plot.

26. A method, comprising:
(a) determining spatial information for each of multiple spatial locations of a first interface of an object based on measurement data of the object;
(b) determining spatial information for each of multiple spatial locations of a second interface of the object based on measurement data of the object and a shape of the second interface; and
(c) determining a distance between the first and second interfaces for each of multiple spatial locations of the object based on the spatial information of the multiple spatial locations of the first interface and the spatial information of the multiple spatial locations of the second interface.

27. The method of claim 26, wherein the first interface is between surroundings of the object and an outer surface of an outer layer of the object.

28. The method of claim 27, wherein the second interface is between an inner surface of the outer layer and a surface of an underlying layer of the object.

29. The method of claim 28, wherein each distance between the first and second interfaces corresponds to a thickness of outer layer.

30. The method of claim 28, wherein the second interface has a higher optical reflectivity than the first interface.

31. The method of claim 26, wherein the measurement data of the step of (a) determining and the measurement data of the step of (b) determining are optical interferometry data.

32. The method of claim 31, wherein the measurement data of the step of (a) determining and the measurement data of the step of (b) determining are low coherence optical interferometry data.

33. The method of claim 26, wherein the step (b) determining comprises determining spatial information for a number N spatial locations of the interface based on measurement data corresponding to a smaller number N′ spatial locations of the object and the shape of the second interface.
